(19) United States
(12) Patent Application Publication
(10) Pub. No.: US 2021/0192421 A1
(43) Pub. Date: Jun. 24, 2021

(54) SKILL DETERMINATION FRAMEWORK FOR INDIVIDUALS AND GROUPS

(71) Applicant: Microsoft Technology Licensing, LLC, Redmond, WA (US)

(72) Inventors: Ananthatejas Raghavan, Redmond, WA (US); Venkata Madhu Sravanth Kurumaddali, Redmond, WA (US); Rashi Anand, Bhopal (IN)

(21) Appl. No.: 16/725,054

(22) Filed: Dec. 23, 2019

(51) Int. Cl. G06Q 10/06; G06N 3/08

(52) U.S. Cl. CPC G06Q 10/063112; G06N 3/08

(57) ABSTRACT

Systems and methods for identifying and verifying skills are provided. A network system accesses data from a plurality of data sources and extracts a plurality of skills from the accessed data for an individual. The network system then assigns a confidence score to each skill of the plurality of skills, whereby the confidence score is based on a heuristically-derived skill level for each skill. The network system generates a unified score for each skill by aggregating confidence scores for a same skill across the plurality of data sources. Based on the unified score for a particular skill exceeding a corresponding skill threshold, the network system identifies the particular skill as a verified skill of the individual and updates a data store with the verified skill of the individual. A further system may then be provided an indication of the verified skill of the individual.

### TECHNICAL FIELD

The subject matter disclosed herein generally relates to special-purpose machines that facilitate determining skills of individuals and groups, and to the technologies by which such special-purpose machines become improved compared to other machines that determine skills. Specifically, the present disclosure addresses systems and methods that verifies skills of individuals and groups based on information extracted from various data sources.

### BACKGROUND

Determining skills and skill levels of individuals is difficult. A person can ask others for such information or search social network sites that present skills (e.g., LinkedIn). However, there is no way for the person to know if the information is accurate. For example, individuals can simply list any skills they desire on a social network site and no verification of those skills is needed or performed.

### BRIEF DESCRIPTION OF DRAWINGS

Various ones of the appended drawings merely illustrate example embodiments of the present invention and cannot be considered as limiting its scope.

FIG. 1 is a diagram illustrating a network environment suitable for determining and verifying skills, according to some example embodiments.

FIG. 2 is a block diagram illustrating components of a skill generation system, according to some example embodiments.

FIG. 3 is a block diagram illustrating components of a skill keyword generator, according to some example embodiments.

FIG. 4 is a flowchart illustrating operations of a method for identifying and verifying skills for an individual, according to some example embodiments.

FIG. 5 is a flowchart illustrating operations of a method for determining a skill set of a group, according to some example embodiments.

FIG. 6 is a block diagram illustrating components of a machine, according to some example embodiments, able to read instructions from a machine-readable medium and perform any one or more of the methodologies discussed herein.

### DETAILED DESCRIPTION

The description that follows includes systems, methods, techniques, instruction sequences, and computing machine program products that embody illustrative embodiments of the present inventive subject matter. In the following description, for purposes of explanation, numerous specific details are set forth in order to provide an understanding of various embodiments of the inventive subject matter. It will be evident, however, to those skilled in the art, that embodiments of the inventive subject matter may be practiced without some or other of these specific details. In general, well-known instruction instances, protocols, structures, and techniques have not been shown in detail. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example embodiments are directed to a system and method that identify and verify skills of an individual and a group (e.g., a team, a department, a project group). In example embodiments, the system accesses data from a plurality of data sources and extracts a plurality of skills from the accessed data for an individual. The system then assigns a confidence score to each skill of the plurality of skills, whereby the confidence score is based on a heuristically-derived skill level for each skill. The confidence score may indicate a level of confidence that the user has a particular skill and/or may indicate a level of that skill. Subsequently, the system generates a unified score for each skill by aggregating confidence scores for a same skill across the plurality of data sources. In some embodiments, weighting may be applied to the confidence scores and/or averages taken during an aggregation process. Based on the unified score for a particular skill exceeding a corresponding skill threshold, the network system identifies the particular skill as a verified skill of the individual and updates a data store with the verified skill of the individual. A further system may then be provided an indication of the verified skill of the individual. A similar process can be used to identified skills for a group of individuals (e.g., by aggregating their unified scores to derive a group unified score).

Thus, the present disclosure provides technical solutions for deriving a skill set for an individual and for groups with a high degree of confidence. The skill sets are derived from analysis of file extensions, analysis of code, determination of package dependencies, keyword searches of text in documents, and identified online certifications. As a result, one or more of the methodologies described herein facilitate solving technical problems associated with managing and analyzing large amounts of data to derive skill sets for individuals and groups. By providing a skill generation system that analyzes the data and uses heuristics to indicate a confidence an individual has in particular identified skills, example embodiments automate a process that is essentially humanly impossible to perform given the sheer amount of data to be accessed, understood, and processed.

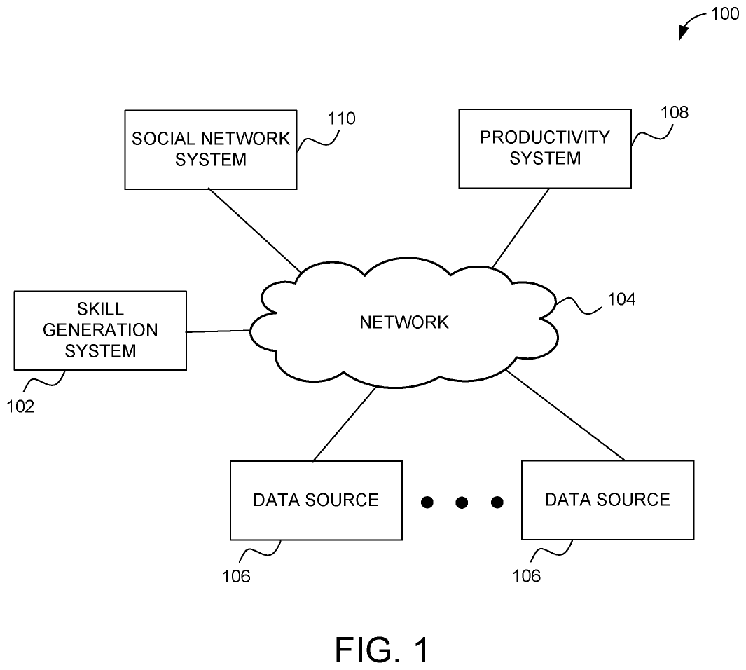

FIG. 1 is a block diagram illustrating an example environment 100 for determining and verifying skills of individuals and groups, in accordance with example embodiments. In example embodiments, a skill generation system 102 is a network system comprising one or more servers that identifies skills associated with individuals and verifies the skills (e.g., determines whether the individual exceeds a threshold to be considered an expert with that skill). The skill generation system 102 may also determine a skill set for a group of individuals. The verified skills and group skill set are stored to a data store and used by further systems or components. Accordingly, the skill generation system 102 comprises components that extract skills, determine likelihood that an individual is an expert in a skill by determining a confidence score, and identify skills that the individual is likely to be an expect. In one embodiment, the skills are technical skills such as, for example, languages (e.g., C #, Java, Python), technologies (e.g., Microsoft Azure, Amazon Web Services (AWS)), technology fields (e.g., machine learning, backend technologies, frontend technologies), design patterns (e.g., factory method pattern, singleton pattern), or architectures (e.g., monolithic, microservices). In alternative embodiments, skills in any field can be determined and/or verified by the skill generation system 102 such as business skills or legal skills. For simplicity of discussion, the following description will discuss skill identification and verification for technical skills.

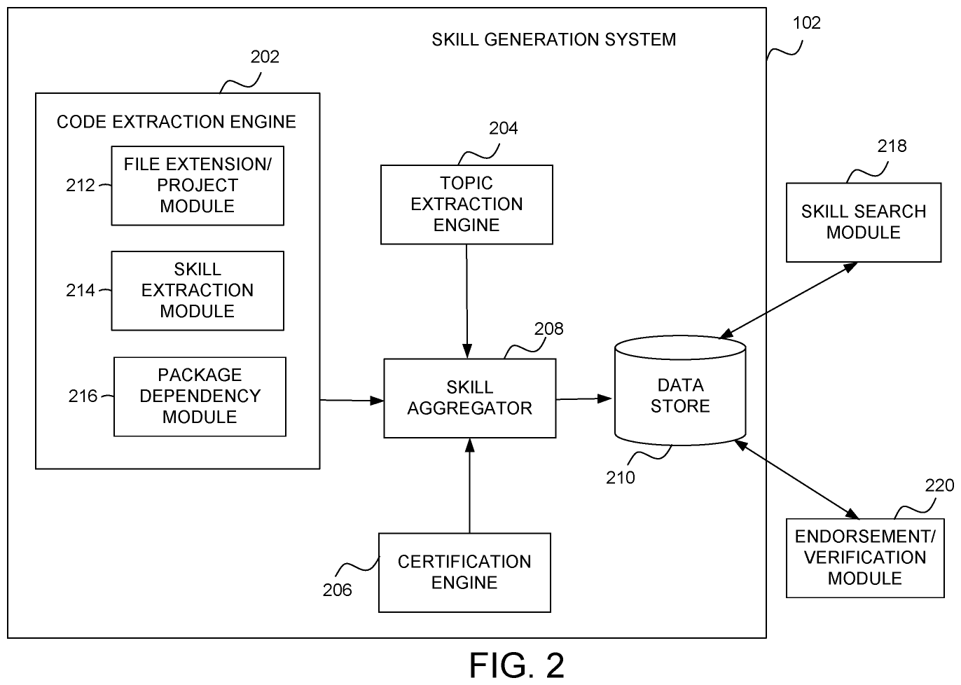

In one embodiment, the skill generation system 102 is associated with a service provider that has access to a repository of knowledge with enterprise customers who write code on certain systems (e.g., Visual Studio Teams System(VSTS) or Github), write design documents using particular office productivity products (e.g., Word, Visio, Excel), store these documents/codes on a certain collaboration platforms (e.g., Sharepoint), and/or deploys the documents/codes on particular cloud computing service (e.g., Microsoft Azure). Using these assets as signals, the skill generation system 102 can identify and verify skills for an individual or group using, for example, heuristic machine learning models. The skill generation system 102 will be discussed in more detail in connection with FIG. 2 below.

The skill generation system 102 accesses, via a communication network 104, a plurality of data sources 106. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) data, and includes digital or analog communication signals or other intangible media to facilitate communication of such software.

The data sources 106 comprise sources that provide the signals for skill determination that is analyzed by the skill generation system 102. In one embodiment, the data sources 106 comprise one or more code repositories, one or more document/file stores (also referred to as “document store”), and/or one or more certification stores. The code repository can include Github, Visual Studio Team Services (VSTS), or any other repository system which contains code and commit history. The document/file store includes documents from office productivity sources such as OneDrive, Word, Visio, OneNote, Outlook, and so forth. The certification store contains online course/certification application programming interfaces (APIs) which can provide information about skills one has experience in based on online courses or training. These APIs may access services such as LinkedIn Learning, Pluralsight, O'Reilly Media that provide online training and certification. Any number and types of data sources 106 may be present in the environment 100.

A productivity system 108 accesses and uses the results of the skill generation system 102. For instance, a user of the productivity system 108 may search for individuals that have a particular verified skill. The user of the productivity system 108 may also search for a group that has particular skills or, alternative, search for top skills for a particular group. In one embodiment, the skill generation system 102 may be a part of the productivity system 108 or owned/managed by a same entity as the productivity system 108. In some embodiments, the productivity system 108 may include one or more of the data sources 106. For example, the productivity system 108 may be (or associate with) Microsoft 365 and includes (or has access to) a code repository, document/file store, and/or the online course/certification APIs.

A social network system 110 also may access and use the results of the skill generation system 102. In one embodiment, the social network system 110 comprises a business social network (e.g., LinkedIn) that allows individuals to post information regarding their work experience and skills. In some embodiments, the social network system 110 accesses the results of the skill generation system 102 to verify skills that individuals have listed on their personal webpage at the social network system 110. Any verified skills of an individual may be indicated on the personal webpage (e.g., with a logo or other icon that indicates the skill is verified). The social network system 110 may also automatically populate a personal webpage of the individual with verified skills from the skill generation system 102. In some embodiments, the social network system 110 may include or be associated with one or more of the data sources 106. For example, the social network system 110 may be LinkedIn and is associated with an online course/certification API to LinkedIn Learning.

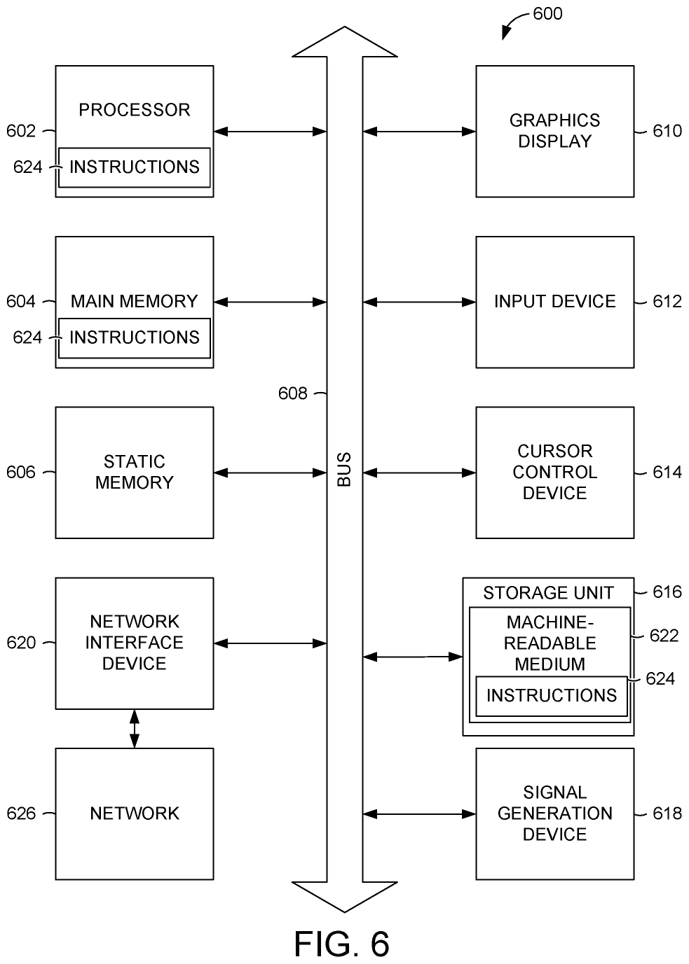

In example embodiments, any of the systems or sources (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or sources illustrated in FIG. 1 may be combined into a single system or device. For example, any one or more of the skill generation system 102, data sources 106, productivity system 108, and social network system 110 may be combined within a single system or be controlled by a single entity. Additionally, some of the functions of the skill generation system 102 may be performed at the productivity system 108 or vice-versa, for example. Furthermore, the functions described herein for any single system or device may be subdivided among multiple systems or devices. Additionally, any number of skill generation systems 102, data sources 106, productivity systems 108, or social network system 110 may be embodied within the network environment 100. Further still, some components or functions of the network environment 100 may be combined or located elsewhere in the network environment 100.

FIG. 2 is a block diagram illustrating components of the skill generation system 102, according to example embodiments. The skill generation system 102 comprises components that extract skills, determine likelihood that an individual is an expert in a skill, and identify skills that the individual is likely to be an expect. To enable these operations, the skill generation system 102 comprises a code extraction engine 102, a topic extraction engine 204, a certification engine 206, a skill aggregator 208, and a data store 210 all configured to communicate with each other (e.g., via a bus, shared memory, or a switch). The skill generation system 102 may also comprise other components (that are not shown) that are not pertinent to example embodiments. Furthermore, any one or more of the components (e.g., engines, modules, storage) described herein may be implemented using hardware (e.g., a processor of a machine) or a combination of hardware and software. Moreover, any two or more of these components may be combined into a single component, and the functions described herein for a single component may be subdivided among multiple components. Further still, some of the components of the skill generation system 102 may be located at the productivity system 108 or vice versa, in various embodiments.

The skill generation system 102 calls multiple microservices which can be extended whenever new data sources or ways to extract skills become available. Each microservice, in turn, uses its own logic to determine skills relevant to an individual based on its data sources. In example embodiments, three microservices are used to determine a skill set for individuals. These microservices are represented in FIG. 2 as the code extraction 202, the topic extraction engine 204, and the certification engine 206.

The code extraction service or code extraction engine 202 is configured to use code checkin information associated with an individual to determine skills the individual are familiar with using heuristics. The code extraction engine 202 identifies the skills based on data from different data repositories and code repositories. In example embodiments, the code extraction engine 202 uses various models to determine skills possessed by the user using a file extension/project module 212, a skill extraction module 214, and a package dependency module 216.

The file extension/project module 212 comprises a rule-based module that uses file extensions of files the individual has worked on and project information to determine major skills of the individual. For example, if the individual has worked on .scala files (filename extensions: scala or .sc) regularly, the file extension/project module 212 identifies the individual as having some expertise in Scala. In another example, if the individual has worked on .csproj files and these files have the worker role tag associated with the file, the file extension/project module 212 identifies that the user is familiar with Azure Worker Roles. Along with determining the skills, the file extension/project module 212 also provides a confidence score based on multiple heuristics. The heuristics may be based on frequency (e.g., number of files/projects and temporal activity of the user). Using the heuristics, a confidence score is associated with each skill extracted or identified by the file extension/project module 212.

The skill extraction module 214 identifies high level skills of the individuals such as, for example, microservices, machine learning, distributed systems, and so forth. The skill extraction module 214 uses code repositories of the individual as input and processes the code repository through a skills keyword model that comprises (or uses) a database of keywords. Specifically, the skill extraction module 214 uses keywords from the skills keyword model to find those keywords in the text of the code. The skill extraction module 214 returns one or more skills and a confidence score associated with each skill.

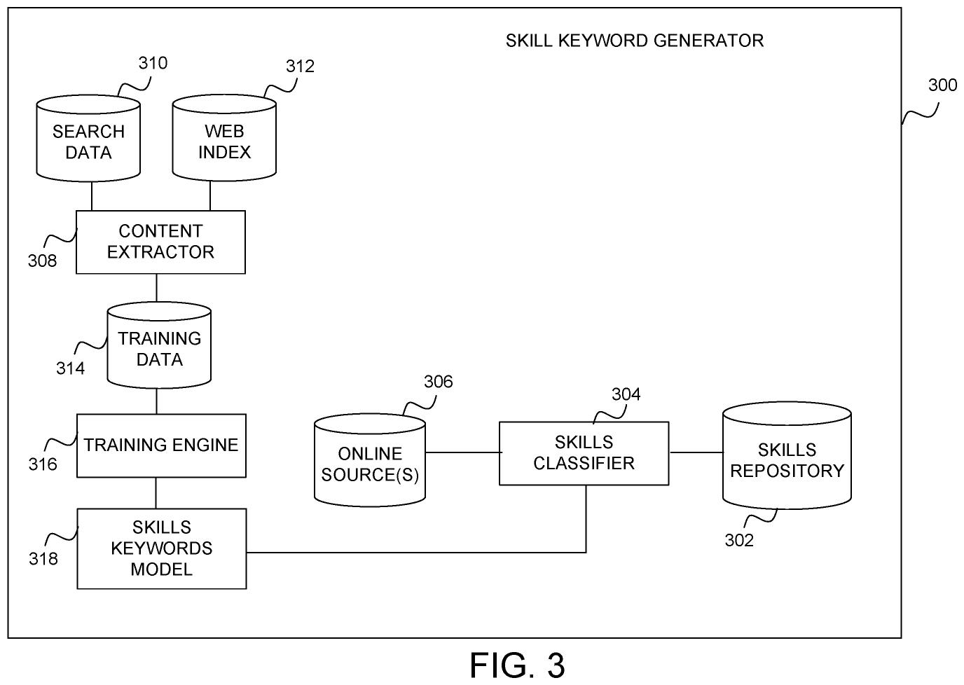

Referring to FIG. 3, a block diagram illustrating components of a skill keyword generator 300, according to some example embodiments, is shown. To create a repository of skills (e.g., skills repository 302), which is used to determine what skills to output, a skills classifier 304 is needed to classify the skills from various sources (e.g., online sources 306). To build the skills classifier 304, the skill keyword generator 300 obtains some set of skills which have high confidence from the online sources 306 (e.g., LinkedIn, career websites). These high confidence online sources 306 may be identified through a web index score and classification tags that use multiple classifiers. These high confidence online sources 306 are crawled and content is processed. In some embodiments, the content from the confidence online sources 306 is filtered out to remove low confidence words and may be run through the skills classifier 304 to identify high confidence keywords and snippets.

The skill keyword generator 300 expands on these high confidence skills using a related content extraction service (e.g., content extractor 308) using related searches (e.g., search data from datastore 310) and a web index (e.g., from web index datastore 312) as additional sources. The skill keyword generator 300 then feeds that data as training data 314 to a training engine 316 to develop a neural network-based skills keywords model 318. The skills keywords model 318 acts as a base model for classification of further online data to add to the skills repository 302. The further online data may be from lower confidence websites which are more generic (e.g., Wikipedia, company websites).

In some embodiments, the data from the online sources 306 can be classified into categories and used to create clusters of topics. For example, “machine learning” is a keyword, but all iterations of it are needed. By using the keywords from various sources as training data 314, a cluster can be created whereby, for example, “machine learning” and “reverse machine learning” are in the same cluster. This generates the skill keywords model 318 which, when given a code snippet, outputs one or more skills related to the snippet.

Returning to FIG. 2, the package dependency module 216 parses code dependencies for the files and determines related skills. Most projects have package dependencies. The packages give data indication of what types of libraries or APIs the user is using, for example. Thus, package dependencies give a high confidence that the user is familiar with certain types of libraries or APIs. The package dependency module 216 determines these familiarities and, using heuristics such as number of lines, frequency of use, and so on, determines how familiar the user is with a given skill. For example, if within a file an individual is using Azure storage APIs, this indicates that the individual is familiar with Azure Storage.

The topic extraction service or topic extraction engine 204 is configured to identify a skill set through analyses of text in user documents or files. For example, if an individual has written a specification document in Word which has a microservice architecture detailed in the document, then the topic extraction engine 204 determines that the individual is familiar with microservice architecture and indicates that as a skill the user is familiar with. The topic extraction engine 204 also determines a confidence score for the skill based on frequency of use or a word, how many related words to the topic is used by the individual, and other such heuristics. The topic extraction engine 204 also uses the corpus from the skill keyword generator 300 to filter on a right skill set.

Another good data source to determine skills are online learning courses. Many individuals use various learning sites such as, for example, Coursera, Pluralsight, and LinkedIn Learning. Using APIs of these learning sites, and with consent of the individual, the certification engine 206 is configured to access data from these data sources as confident signals to determine what the user is an expert in. Thus, for example, if an individual has taken a course in a particular subject matter, the individual may be assumed to have one or more skills corresponding to that subject matter.

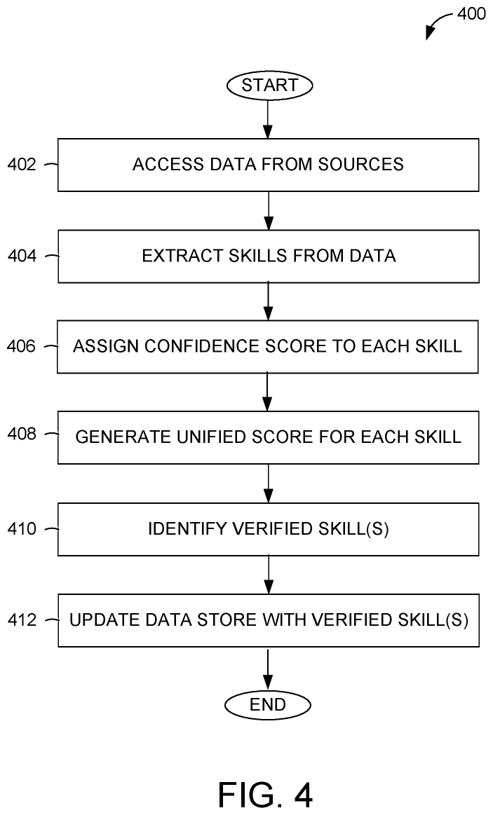

The skill aggregator 208 receives the outputs from the code extraction engine 202, the topic extraction engine 204, and the certification engine 206 and uses aggregation logic to combine the outputs to derive a final list of skills (also referred to herein as “verified skills”) with corresponding (unified) confidence scores for the individual. The results or outputs are stored to the data store 210. A method for identifying and verifying skills for an individual will be discussed in more detail in connection with FIG. 4 below.

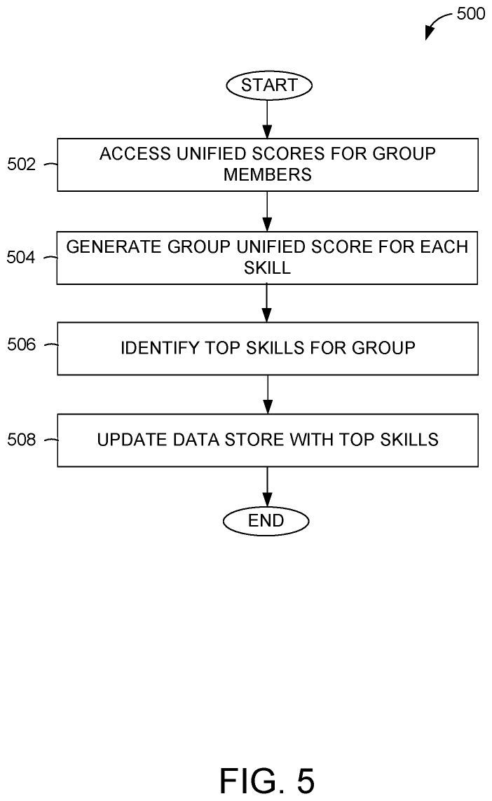

The same logic can be used with respect to a group to generate a skill set for the group. That is, the verified skills (along with corresponding unified confidence scores) for each individual in the group are determined and then aggregated for the group. A method for determining a skill set for a group will be discussed in more detail in connection with FIG. 5 below.

In example embodiments, a skill search module 218 accesses the stored skill sets in the data store. The skill search module 218 may be embodied within the productivity system 108 in accordance with some embodiments. In one embodiment, the skill search module 218 receives a search request from a user of the productivity system 108 to search for individuals or a group having an indicated skill. In response, the skill search module 218 accesses the data store 210 to identify the individuals or group with the indicated skill. The skill search module 218 may rank the individuals (or group) based on a corresponding unified confidence score for each individual (or group) for the indicated skill and present the results of the ranking. In another embodiment, the skill search module 218 may receive a search request identifying a group and requesting the skill set for the group. In this embodiment, the skills in the skill set may be ranked back on a unified (group) confidence score for each skill in the skill set. The skill search module 218 can be used by a user to search for any skill related data stored in the data store 210.

In some embodiments, an endorsement/verification module 220 uses the skill sets in the data store to update a webpage of an individual with skills or verification of skills. For example, the endorsement/verification module 220 can cause presentation of an indication that a skill listed on a webpage of an individual on a social network site (e.g., a professional network site such as LinkedIn) is verified (e.g., with a logo or symbol next to the skill). In another example, the endorsement/verification module 220 can cause an automatic update to a webpage of the individual on the social network site to include a verified skilled that is not already listed. The endorsement/verification module 220 may be embodied within the social network system 110 in accordance with some embodiments.

FIG. 4 is a flowchart illustrating operations of a method 400 for identifying and verifying skills for an individual, according to some example embodiments. Operations in the method 400 may be performed by the skill generation system 102, using components described above with respect to FIG. 2. Accordingly, the method 400 is described by way of example with reference to the skill generation system 102. However, it shall be appreciated that at least some of the operations of the method 400 may be deployed on various other hardware configurations or be performed by similar components residing elsewhere in the network environment 100. Therefore, the method 400 is not intended to be limited to the skill generation system 102.

In operation 402, components of the skill generation system 102 access data from the plurality of data sources 106. In one embodiment, the plurality of data sources 106 comprise one or more code repositories, one or more document/file stores, and/or one or more certification stores. Accordingly, the components of the skill generation system 102 that access the data may comprise a code extraction engine 202 to access data in a code repository, a topic extraction engine 204 to access data in a document/file store, and a certification engine 206 to access data from a certification store.

In operation 404, the components of the skill generation system 102 extract, from the accessed data, skills for an individual. In example embodiments, the code extraction engine 202 extracts skills from the data accessed from the code repository using the file extension/project module 212, the skill extraction module 214, and/or the package dependency module 216. The file extension/project module 212 uses file extensions of files the individual has worked on and project information to determine major skills of the individual. The skill extraction module 214 identifies high level skills of the individuals such as, for example, microservices, machine learning, distributed systems, and so forth by processing code from the code repository through a skills keyword model. The package dependency module 216 parses code dependencies for the files and determines from the dependencies corresponding skills.

Similarly, the topic extraction engine 204 identifies one or more skills through analyses of text in user documents or files accessed from the document/file stores. For example, if an individual has written a specification document in Word which has a microservice architecture detailed in the document, then the topic extraction engine 204 determines that the individual is familiar with microservice architecture and indicates that as a skill the user is familiar with. In some embodiments, the topic extraction engine 204 uses a corpus from the skill keyword generator to filter on a right skill set.

The certification engine 206 uses APIs of online training/learning sites to access the data from these sites. The data from these sites provide signals to determine what the user is an expert in. For example, if the user took a course in C++, then the certification engine 206 will identified C++ as a skill for the individual.

In operation 406, the components of the skill generation system 102 assign a confidence score to each extracted skill. In example embodiments, the confidence score is in a range from 0.0 to 1.0. In some embodiments, operation 404 and 406 occur substantially simultaneously. That is the determination of the skill and the corresponding confidence score may occur together or be dependent on one another.

With respect to skills identified by the file extension/project module 212, the file extension/project module 212 provides a confidence score based on multiple heuristics (also referred to herein as “heuristically-derived skill levels”). In example embodiments, the heuristics are based on, for example, number of files/projects and temporal activities of the individual. That is, the confidence score is based on frequency of use. For example, if the individual has worked on or created a particular type of file 10 times, that skill will be assigned a score of 0.5, while work/creation of a particular type of file 20 times results in the skill being assigned a score of 0.8. Using the heuristics, a confidence score is associated with each skill extracted or identified by the file extension/project module 212.

The skill extraction module 214 uses code repositories of the individual as input and processes the code repository through a skills keyword model which returns a set of one or more skills and a confidence score associated with each skill in the set. In one embodiment, the skill extraction module 214 may perform a count for each keyword identified from the code for each skill. Based on that count and heuristics, a confidence score is assigned to each skill. For example, if “Azure” is extracted 10 times from codes, then a confidence score of 0.4 may be assigned, while extraction of “Azure” 25 times form codes will cause a confidence score of 0.7 to be assigned to the skill “Azure.”

The package dependency module 216 determines familiarity based on package dependences (e.g., use of particular resources or libraries). Using heuristics such as number of lines, frequency of use, and so on, the package dependence module 216 determines how familiar the user is with a given skill. For example, if the individual uses a particular library, the package dependencies gives a high confidence that the user is using this type of library and will assign, based on heuristics, a corresponding confidence score. For instance, more frequency of use of a particular type of library will result in a higher confidence score for a skill associated with that particular type of library.

The topic extraction engine 204 determines a confidence score for a skill extracted by the topic extraction engine 204 based on frequency of use, how many related words to the topic is used by the individual, and other such heuristics. Similar with the other components of the skill generation system 102, the confidence score is a function of the frequency of use or based on a counter (e.g., number of related words to the topic used).

The certification engine 206 is configured to use data from the online training/learning sites as confident signals to assign the confidence score. For example, if the individual takes a course in a particular language or subject matter, there is a high confidence that the individual is a skilled expert in that language or subject matter. In one embodiment, the confidence score assigned would be 1.0. In an alternative embodiment, a grade or other form of evaluation may be associated with the course and the confidence score is derived from the grade or evaluation (e.g., A=1.0; B=0.8; C=0.6).

In operation 408, the skill aggregator 208 generates a unified confidence score (also referred to herein as “unified score”) for each skill across the plurality of data sources 106. The skill aggregator 208 aggregates the data (e.g., skills and corresponding confidence scores) from all the different services/components of the skill generation system 102. In some embodiments, the skill aggregator 208 combines, for each extracted skill, the confidence score from each service/component and obtains a unified confidence score for that skill. In some embodiments, the skill aggregator 208 determines a unified confidence score by taking an average of the confidence scores for each extracted skill. In some embodiments, the skill aggregator 208 may normalize the confidence scores for the same skill and take an average. Further still, the skill aggregator 208 can apply weights to the confidence scores from the different components during an aggregation process. For example, a certification score (e.g., confidence score for a skill extracted by the certification engine 206) is a strong indicator of the individual being an expert in a corresponding skill so it may be weighted higher compared to a confidence score for the same skill extracted by the topic extraction engine 204. Any combination of combining, averaging, normalizing, and/or weighting may be used to determine a unified confidence score, or other calculations may be performed to obtain the unified confidence score.

In operation 410, the skill aggregator 208 identifies the verified skills. As used herein, “verified skills” refer to skills that have a unified confidence score that exceeds a predetermined threshold for that skill. In some embodiments, the predetermined threshold may also be heuristic based or derived.

In operation 412, the skill aggregator 208 updates the data store 210 with the verified skills. In some embodiments, the verified skills are sorted based on their corresponding unified score before storing in the data store 210.

FIG. 5 is a flowchart illustrating operations of a method 500 for determining skills of a group, according to some example embodiments. Operations in the method 500 may be performed by the skill generation system 102, using components described above with respect to FIG. 2. Accordingly, the method 500 is described by way of example with reference to the skill generation system 102 (e.g., the skill aggregator 208). However, it shall be appreciated that at least some of the operations of the method 500 may be deployed on various other hardware configurations or be performed by similar components residing elsewhere in the network environment 100. Therefore, the method 500 is not intended to be limited to the skill generation system 102.

In operation 502, the skill aggregator 208 accesses the (individual) unified scores of skills for every individual in the group. The unified scores can be accessed from the data store 210.

In operation 504, the skill aggregator 208 generates a group unified score for each skill. Similar to generating the unified score for a skill of an individual, the skill aggregator 208 combines, for each skill, the unified score from individuals and obtains a group unified score for that skill. In some embodiments, the skill aggregator 208 may normalize the individual unified scores for the same skill and take an average and/or apply weights to the individual unified score.

In operation 506, the skill aggregator 208 identifies top skills for the group. Accordingly, the skill aggregator 208 may rank the skills based on the group unified score and identify a top number (e.g., top 5) of skills with the highest group unified score.

In operation 508, the skill aggregator 208 updates the data store 210 with the top skills for the group. The group skills can be accessed (e.g., via a search query) or provided to further systems for use (e.g., the productivity system 108 may present top skills for a group in an organizational presentation).

FIG. 6 illustrates components of a machine 600, according to some example embodiments, that is able to read instructions from a machine-readable medium (e.g., a machine-readable storage device, a non-transitory machine-readable storage medium, a computer-readable storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagrams of FIG. 4 and FIG. 5. In one embodiment, the instructions 624 can transform the general, non-programmed machine 600 into a particular machine (e.g., specially configured machine) programmed to carry out the described and illustrated functions in the manner described.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 1002 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-readable medium 622 (e.g., a tangible machine-readable storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-readable media (e.g., tangible and non-transitory machine-readable media). The instructions 624 may be transmitted or received over a network 626 via the network interface device 620.

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 622 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### EXAMPLES

Example 1 is a method for identifying and verifying skills. The method comprises accessing data from a plurality of data sources; extracting, by a hardware processor, a plurality of skills from the accessed data for an individual; assigning a confidence score to each skill of the plurality of skills, the confidence score being based on a heuristically-derived skill level for each skill; generating a unified score for each skill by aggregating confidence scores for a same skill across the plurality of data sources; based on the unified score for a particular skill exceeding a corresponding skill threshold, identifying the particular skill as a verified skill of the individual; updating a data store with the verified skill of the individual; and providing an indication of the verified skill of the individual to a further system.

In example 2, the subject matter of example 1 can optionally include wherein the plurality of data sources comprises one or more code repositories, document stores, and certification stores.

In example 3, the subject matter of any of examples 1-2 can optionally include wherein the generating the unified score comprises applying a weight to the confidence score for a skill from a particular data source, the weight being higher for a score from the certification stores than from the code repositories and the document stores.

In example 4, the subject matter of any of examples 1-3 can optionally include wherein the extracting the plurality of skills comprises using a skills keywords model to identify one or more of the plurality of skills, the method further comprising using a neural network to train the skills keywords model.

In example 5, the subject matter of any of examples 1-4 can optionally include wherein the extracting the plurality of skills comprises identifying a skill of the plurality of skills by identifying file extensions of files the individual has worked on, the file extensions indicating the skill.

In example 6, the subject matter of any of examples 1-5 can optionally include wherein the extracting the plurality of skills comprises identifying a skill of the plurality of skills based on code accessed from a code repository matching one or more keywords from a skill keywords model.

In example 7, the subject matter of any of examples 1-6 can optionally include wherein the extracting the plurality of skills comprises identifying a skill of the plurality of skills based on identified package dependencies, the identified package dependencies indicating the skill.

In example 8, the subject matter of any of examples 1-7 can optionally include wherein the extracting the plurality of skills comprises identifying a skill of the plurality of skills based on text in documents or files accessed from a document store matching one or more keywords from a skill keywords model.

In example 9, the subject matter of any of examples 1-8 can optionally include wherein the extracting the plurality of skills comprises identifying, from data accessed from a certification store, a skill of the plurality of skills based on the individual having completed a training course associated with the skill.

In example 10, the subject matter of any of examples 1-9 can optionally include wherein the providing the indication of the verified skill comprises causing presentation of an indication that the verified skill is verified on a webpage associated with the individual on a social network site; or causing an automatic update to a webpage associated with the individual on a social network site to include an indication of the verified skill.

In example 11, the subject matter of any of examples 1-10 can optionally include wherein the generating the unified score comprises taking an average of the confidence scores for the same skill across the plurality of data sources.

In example 12, the subject matter of any of examples 1-11 can optionally include wherein the providing the indication of the verified skill comprises receiving a search request for individuals having the verified skill; searching the data store for individuals having the verified skill; ranking the individuals based on the unified score for each of the individuals having the verified skill; and causing display of a result of the ranking.

In example 13, the subject matter of any of examples 1-12 can optionally include deriving skills for a group that the individual is a member of, the derived skills including the verified skill of the individual.

In example 14, the subject matter of any of examples 1-13 can optionally include receiving a search request for skills associated with the group; and in response to the search request, causing presentation of the derived skills for the group.

Example 15 is a system for identifying and verifying skills. The system includes one or more processors and a storage device storing instructions that, when executed by the one or more hardware processors, causes the one or more hardware processors to perform operations comprising accessing data from a plurality of data sources; extracting a plurality of skills from the accessed data for an individual; assigning a confidence score to each skill of the plurality of skills, the confidence score being based on a heuristically-derived skill level for each skill; generating a unified score for each skill by aggregating confidence scores for a same skill across the plurality of data sources; based on the unified score for a particular skill exceeding a corresponding skill threshold, identifying the particular skill as a verified skill of the individual; updating a data store with the verified skill of the individual; and providing an indication of the verified skill of the individual to a further system.

In example 16, the subject matter of example 15 can optionally include wherein the extracting the plurality of skills comprises using a skills keywords model to identify one or more of the plurality of skills, the method further comprising using a neural network to train the skills keywords model.

In example 17, the subject matter of any of examples 15-16 can optionally include wherein the providing the indication of the verified skill comprises receiving a search request for individuals having the verified skill; searching the data store for individuals having the verified skill; ranking the individuals based on the unified score for each of the individuals having the verified skill; and causing display of a result of the ranking.

In example 18, the subject matter of any of examples 15-17 can optionally include wherein the providing the indication of the verified skill comprises causing presentation of an indication that the verified skill is verified on a webpage associated with the individual on a social network site; or causing an automatic update to a webpage associated with the individual on a social network site to include an indication of the verified skill.

In example 19, the subject matter of any of examples 15-18 can optionally include wherein the operations further comprise deriving skills for a group that the individual is a member of, the derived skills including the verified skill of the individual.

Example 20 is a machine-storage medium storing instructions for identifying and verifying skills. The machine-storage medium configures one or more processors to perform operations comprising accessing data from a plurality of data sources; extracting a plurality of skills from the accessed data for an individual; assigning a confidence score to each skill of the plurality of skills, the confidence score being based on a heuristically-derived skill level for each skill; generating a unified score for each skill by aggregating confidence scores for a same skill across the plurality of data sources; based on the unified score for a particular skill exceeding a corresponding skill threshold, identifying the particular skill as a verified skill of the individual; updating a data store with the verified skill of the individual; and providing an indication of the verified skill of the individual to a further system.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
accessing data from a plurality of data sources;
extracting, by a hardware processor, a plurality of skills from the accessed data for an individual;
assigning a confidence score to each skill of the plurality of skills, the confidence score being based on a heuristically-derived skill level for each skill;
generating a unified score for each skill by aggregating confidence scores for a same skill across the plurality of data sources;
based on the unified score for a particular skill exceeding a corresponding skill threshold, identifying the particular skill as a verified skill of the individual;
updating a data store with the verified skill of the individual; and
providing an indication of the verified skill of the individual to a further system.

2. The method of claim 1, wherein the plurality of data sources comprises one or more code repositories, document stores, and certification stores.

3. The method of claim 2, wherein the generating the unified score comprises applying a weight to the confidence score for a skill from a particular data source, the weight being higher for a score from the certification stores than from the code repositories and the document stores.

4. The method of claim 1, wherein the extracting the plurality of skills comprises using a skills keywords model to identify one or more of the plurality of skills, the method further comprising using a neural network to train the skills keywords model.

5. The method of claim 1, wherein the extracting the plurality of skills comprises identifying a skill of the plurality of skills by identifying file extensions of files the individual has worked on, the file extensions indicating the skill.

6. The method of claim 1, wherein the extracting the plurality of skills comprises identifying a skill of the plurality of skills based on code accessed from a code repository matching one or more keywords from a skill keywords model.

7. The method of claim 1, wherein the extracting the plurality of skills comprises identifying a skill of the plurality of skills based on identified package dependencies, the identified package dependencies indicating the skill.

8. The method of claim 1, wherein the extracting the plurality of skills comprises identifying a skill of the plurality of skills based on text in documents or files accessed from a document store matching one or more keywords from a skill keywords model.

9. The method of claim 1, wherein the extracting the plurality of skills comprises identifying, from data accessed from a certification store, a skill of the plurality of skills based on the individual having completed a training course associated with the skill.

10. The method of claim 1, wherein the providing the indication of the verified skill comprises:
causing presentation of an indication that the verified skill is verified on a webpage associated with the individual on a social network site; or
causing an automatic update to a webpage associated with the individual on a social network site to include an indication of the verified skill.

11. The method of claim 1, wherein the generating the unified score comprises taking an average of the confidence scores for the same skill across the plurality of data sources.

12. The method of claim 1, wherein the providing the indication of the verified skill comprises:
receiving a search request for individuals having the verified skill;
searching the data store for individuals having the verified skill;
ranking the individuals based on the unified score for each of the individuals having the verified skill; and
causing display of a result of the ranking.

13. The method of claim 1, further comprising deriving skills for a group that the individual is a member of, the derived skills including the verified skill of the individual.

14. The method of claim 13, further comprising;
receiving a search request for skills associated with the group; and
in response to the search request, causing presentation of the derived skills for the group.

15. A system comprising:
one or more hardware processors; and
a storage device storing instructions that, when executed by the one or more hardware processors, causes the one or more hardware processors to perform operations comprising:
accessing data from a plurality of data sources;
extracting a plurality of skills from the accessed data for an individual;
assigning a confidence score to each skill of the plurality of skills, the confidence score being based on a heuristically-derived skill level for each skill;
generating a unified score for each skill by aggregating confidence scores for a same skill across the plurality of data sources;
based on the unified score for a particular skill exceeding a corresponding skill threshold, identifying the particular skill as a verified skill of the individual;
updating a data store with the verified skill of the individual; and
providing an indication of the verified skill of the individual to a further system.

16. The system of claim 15, wherein the extracting the plurality of skills comprises using a skills keywords model to identify one or more of the plurality of skills, the method further comprising using a neural network to train the skills keywords model.

17. The system of claim 15, wherein the providing the indication of the verified skill comprises:
receiving a search request for individuals having the verified skill;
searching the data store for individuals having the verified skill;
ranking the individuals based on the unified score for each of the individuals having the verified skill; and
causing display of a result of the ranking.

18. The system of claim 15, wherein the providing the indication of the verified skill comprises:
causing presentation of an indication that the verified skill is verified on a webpage associated with the individual on a social network site; or
causing an automatic update to a webpage associated with the individual on a social network site to include an indication of the verified skill.

19. The system of claim 15, wherein the operations further comprise deriving skills for a group that the individual is a member of, the derived skills including the verified skill of the individual.

20. A machine-readable storage medium storing instructions that, when executed by one or more processors of a machine, cause the one or more processors to perform operations comprising:
accessing data from a plurality of data sources;
extracting a plurality of skills from the accessed data for an individual;
assigning a confidence score to each skill of the plurality of skills, the confidence score being based on a heuristically-derived skill level for each skill;
generating a unified score for each skill by aggregating confidence scores for a same skill across the plurality of data sources;
based on the unified score for a particular skill exceeding a corresponding skill threshold, identifying the particular skill as a verified skill of the individual;
updating a data store with the verified skill of the individual; and
providing an indication of the verified skill of the individual to a further system.
